(19) United States
(12) Patent Application Publication
(10) Pub. No.: US 2009/0244553 A1
(43) Pub. Date: Oct. 1, 2009

(54) IMAGE PROCESSING SYSTEM AND IMAGE PROCESSING METHOD

(75) Inventor: Nobuhiko Nakahara, Susono-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/054,603

(22) Filed: Mar. 25, 2008

(51) Int. Cl. G06F 3/12

(52) U.S. Cl. 358/1.1

(57) ABSTRACT

An image processing system according to the invention is an image processing system including a printer driver-containing apparatus in which a printer driver is included, an image processing apparatus connected to the printer driver-containing apparatus, and a display apparatus connected to the printer driver-containing apparatus and having a display section. The image processing apparatus has a halftone processing unit configured to perform halftone processing of bitmap data, and a halftone setting unit configured to carry out setting of the halftone processing.

### BACKGROUND OF THE INVENTION

1. Technical Field of the Invention

The present invention relates to an image processing technique, and particularly to an image processing system and an image processing method that enable detailed setting of halftone processing by a user.

2. Related Art

Recently, multi-function peripherals (MFP) have become popular as image processing apparatuses that integrally handle various forms of digitized image data for a copy machine, printer, scanner, facsimile and so on, temporarily store the image data in a storage medium such as a hard disk drive (HDD), and then reuse the image data.

Image data handled by an image processing apparatus such as an MFP is created from at least one of documents, graphics and photographs created and edited by a host computer, personal computer and so on.

These documents, graphics and photographs are converted into a page description language (PDL) such as Postscript or PCL by a printer driver and then sent to a printer section of the image processing apparatus via relay means such as a local area network (LAN) and a universal serial bus (USB).

The printer section of the image processing apparatus has a controller and an engine. The controller performs raster image processing (RIP) to interpret the PDL and rasterize to raster data (image data of scanning line system), and thus creates bitmap image data. The bitmap image data created by the controller is converted to a driving signal by the engine, and carrying of a sheet, driving control of a laser and so on are carried out. Thus, printing is carried out.

Moreover, in the controller of the image processing apparatus, color conversion processing and halftone processing (pseudo-gradation processing) are usually carried out. The color conversion processing is to convert image data from an RGB color space or the like into a CMYK color space or the like that is suitable for printing. C represents cyan. M represents magenta. Y represents yellow. K represents black.

Color conversion processing is carried out in order to enable an output apparatus such as a printer to handle image data in view of the fact that an output apparatus such as a printer generally handles image data in a CMY color space or CMYK color space in which each color of CMY or CMYK consists of 8 bits.

Meanwhile, halftone processing is carried out by a dither method using a threshold matrix or density pattern method.

In halftone processing, halftone cells each of which includes one pixel or 2ⁿ pixels are usually used, and the outputs of these halftone cells are on-off binary outputs or multi-value outputs including on, off, and intermediate outputs. As the output of each halftone cell is controlled, gradation is expressed by area modulation.

In the case where image data represents a monochrome image, the control of the output of each halftone cell in halftone processing is usually carried out only for K (black).

On the other hand, in the case where image data represents a color image, the control of the output of each halftone cell in halftone processing is carried out for each of the three colors of C (cyan), M (magenta) and Y (yellow) or the four colors of C, M, Y and K.

That is, in halftone processing of a color image, the control of the output of each halftone cell is carried out for each of the three colors of C, M and Y, or the four colors of C, M, Y and K, and micro dots of the three colors or the four colors are superimposed on a final print surface. A fine color gradation image is thus reproduced.

In halftone processing of a color image, image data is created in which one pixel has the three colors of C, M and Y or the four colors of C, M, Y and K, and which has a gradation reproducing capability with the number of bits for one pixel per color being 1 to 8 bits.

The gradation reproducing capability of the created image data is decided in accordance with the printing capability of an output device from which the image data is outputted.

Halftone processing is closely associated with the properties of the engine. For example, if a parameter of halftone processing is changed, problems occur such as increase in granularity, generation of texture and hence substantial deterioration in image quality, change in gamma property of the reproduced image as a whole, and so on. Therefore, a user has not been able to easily change parameters of halftone processing.

Specifically, the conventional halftone processing is carried out in a manner that the manufacturer has prepared in advance plural parameters including the parameter of gamma correction as various modes and the user selects a mode suitable for the printing purpose from the printer driver. Image data is processed by halftone processing in the mode selected by the user and then outputted as a printer output by the engine.

However, recently, many more users want to realize their preferred halftone outputs such as printing simulation and newspaper simulation. Therefore, a method of flexibly providing desired halftone outputs to these users is considered.

For example, there is a method in which the number of halftone parameters prepared in the body in advance, which is of approximately two or three types, is increased further to about ten types and the user is enabled to select a desired one from the large number of halftone parameters via the printer driver. There is also a method having a mechanism to allow more detailed setting of the number of lines (LPI), angle, dot shape and so on by using the Type 1 dictionary of halftone, which is a standard function of Postscript.

The method of selecting a desired one from the large number of prepared halftone tables has a problem that the degree of freedom in selection is low and may not enable the user to realize a necessary halftone output.

Also, the halftone designation method using the standard function of Postscript has a problem that, basically, only halftone processing of 1 bit (binary value) with low resolution can be realized and highly satisfactory image quality cannot be provided. This designation method also has a problem that calibration must be carried out for gamma correction, which is troublesome.

As a method that utilizes dither, of halftone processing, JP-A-11-187265 discloses an image processing method in which the dither threshold order of a dither threshold array is regularly arranged with an inclination angle in a slant direction so that the array lies across plural dither threshold planes. However, this image processing method does not solve the above problems.

### SUMMARY OF THE INVENTION

In view of the foregoing circumstance, it is an object of the invention to provide an image processing system and an image processing method that enable a user to carry out setting of halftone processing with a high degree of freedom.

To achieve the above object, an image processing system according to an aspect of the invention is an image processing system including a printer driver-containing apparatus in which a printer driver is included, an image processing apparatus connected to the printer driver-containing apparatus, and a display apparatus connected to the printer driver-containing apparatus and having a display section. The image processing apparatus has a halftone processing unit configured to perform halftone processing of bitmap data, and a halftone setting unit configured to carry out setting of the halftone processing.

Also, to achieve the above object, an image processing system according to another aspect of the invention is an image processing system including a printer driver-containing apparatus in which a printer driver is included, an image processing apparatus connected to the printer driver-containing apparatus, and a display apparatus connected to the printer driver-containing apparatus and having a display section. The printer driver included in the printer driver-containing apparatus has a halftone setting unit configured to carry out setting of halftone processing in the image processing apparatus. The image processing apparatus has a halftone processing unit configured to perform halftone processing of bitmap data.

Moreover, to achieve the above object, an image processing method according to still another aspect of the invention includes carrying out setting of halftone processing at a halftone processing unit, by a halftone setting unit provided in an image processing apparatus, and performing halftone processing of bitmap data by the halftone processing unit in accordance with the setting of halftone processing.

### BRIEF DESCRIPTION OF THE DRAWINGS

In the attached drawings,

FIG. 1 is a schematic block diagram of an image processing system of a first embodiment according to the invention;

FIG. 2 is a functional block diagram of the image processing system of the first embodiment according to the invention;

FIG. 3 is a view showing an exemplary setting screen by a halftone setting unit, displayed on an operation panel of the an image processing apparatus included in the image processing system of the first embodiment according to the invention;

FIG. 4 is a flowchart showing the operation of the image processing system of the first embodiment according to the invention;

FIG. 5 is a functional block diagram of an image processing system of a second embodiment according to the invention;

FIG. 6 is a view showing an exemplary setting screen by a halftone setting unit, displayed in a display section of the display apparatus included in the image processing system of the second embodiment according to the invention; and

FIG. 7 is a flowchart showing the operation of the image processing system of the second embodiment according to the invention.

### DETAILED DESCRIPTION OF THE PREFERRED EMBODIMENTS

Embodiments of an image processing system according to the invention will be described with reference to the attached drawings.

### First Embodiment

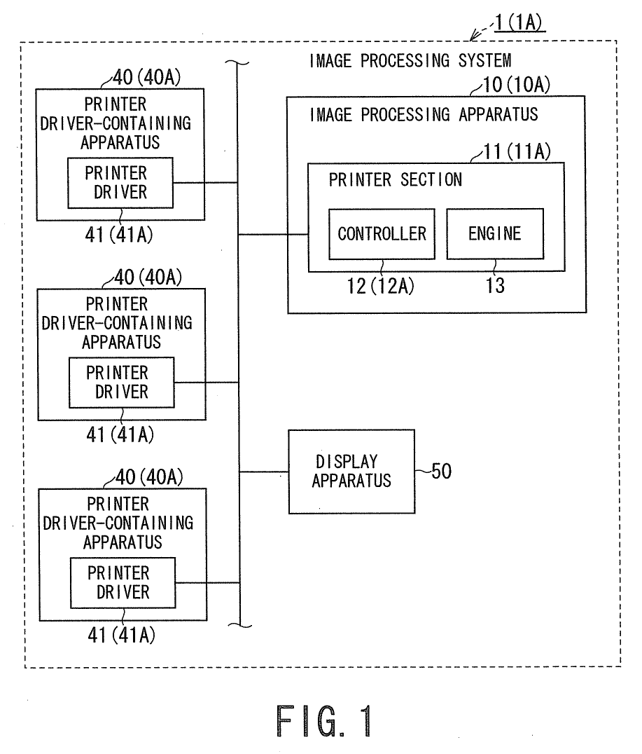

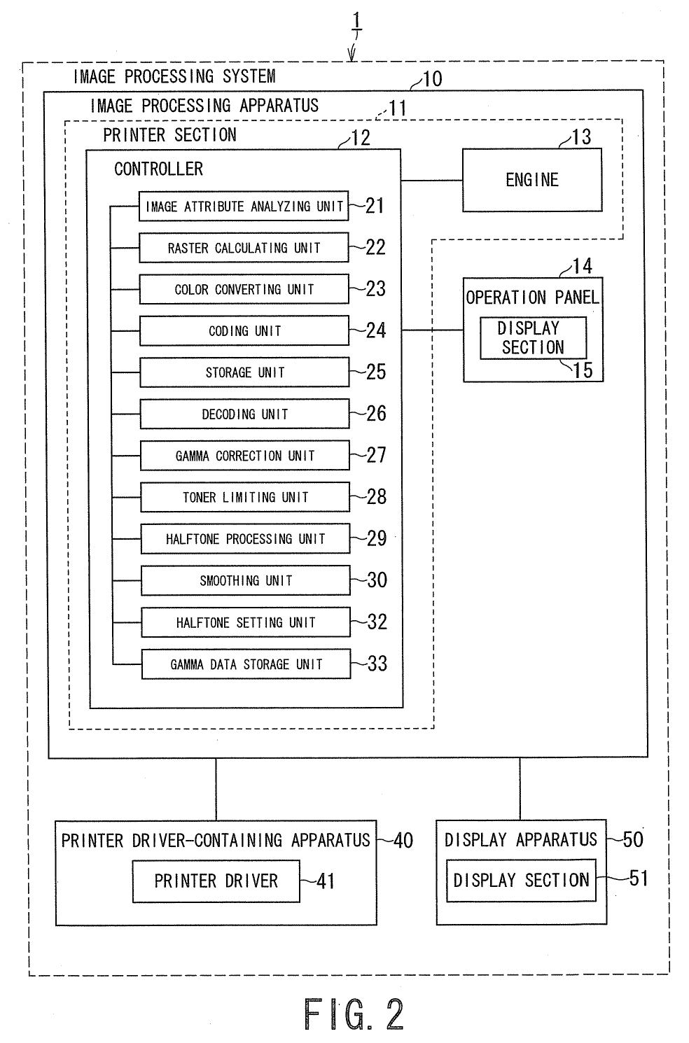

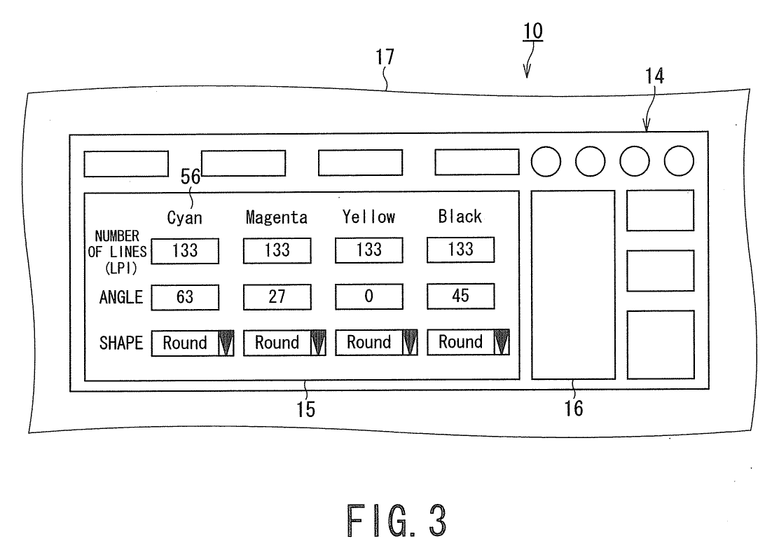

FIG. 1 is a schematic block diagram showing a first embodiment of an image processing system 1 according to the invention. FIG. 2 is a functional block diagram of the image processing system 1. FIG. 3 is a view showing an example of a setting screen 56 by a halftone setting unit 32, displayed on an operation panel 14 of an image processing apparatus 10 included in the image processing system 1.

The image processing system 1 includes the image processing apparatus 10, a printer driver-containing apparatus 40, and a display apparatus 50, as shown in FIG. 1.

The image processing apparatus 10 is a so-called multi-function peripheral (MFP) and includes a printer section 11, and a facsimile section and so on, not shown.

The printer section 11 includes a controller 12 and an engine 13.

The printer driver-containing apparatus 40 is an apparatus that includes a printer driver 41. The printer driver-containing apparatus 40 creates PDL codes and raster data and transfers them to the image processing apparatus 10. For example, a personal computer is used as the printer driver-containing apparatus 40.

The display apparatus 50 is an apparatus that includes a display section 51 capable of displaying images. For example, a liquid crystal display or cathode ray tube (CRT) is used as the display apparatus 50.

The image processing apparatus 10 and the printer driver-containing apparatus 40 can mutually transmit information via LAN connection or the like. Meanwhile, the display apparatus 50 is connected to the printer driver-containing apparatus 40.

The image processing apparatus 10 will be described in detail with reference to FIG. 2.

The image processing apparatus 10 includes the printer section 11 and the operation panel 14.

As shown in FIG. 2, the controller 12 constituting the printer section 11 includes an image attribute analyzing unit 21, a raster calculating unit 22, a color converting unit 23, a coding unit 24, a storage unit 25, a decoding unit 26, a gamma correction unit 27, a toner limiting unit 28, a halftone processing unit 29, a smoothing unit 30, a halftone setting unit 32, and a gamma data storage unit 33.

In the controller 12, the image attribute analyzing unit 21, the raster calculating unit 22, the color converting unit 23, the coding unit 24, the storage unit 25, the decoding unit 26, the gamma correction unit 27, the toner limiting unit 28, the halftone processing unit 29, the smoothing unit 30, the halftone setting unit 32 and the gamma data storage unit 33 are electrically connected to each other and can mutually transmit information.

From code data in a page description language (PDL code data) received from the printer driver-containing apparatus 40, the image attribute analyzing unit 21 analyzes an attribute of image data included in the PDL code data and classifies the type of the image data.

The type of image data corresponds to one of text, graphic, and photo bitmap attributes. The attribute of the image data is created as a tag separately from the image data and is subject to subsequent processing. For example, if image data has the above three types of attributes, its tag data is 2 bits.

The raster calculating unit 22 converts the code data in the page description language (PDL code data) into bitmap data.

In the case where the printer section 11 is used as a color printer, for example, the PDL code data is converted into bitmap data in which each of RGB colors consists of 8 bits, and so on. On the other hand, in the case where the printer section 11 is used as a monochrome printer, for example, the PDL code data is converted into bitmap data with a single color of 8 bits, and so on. Here, R, G and B represent the colors of red, green, and blue, respectively.

To the resulting bitmap data, tag data corresponding to the position where the bitmap data exists is allocated as well.

The color converting unit 23 converts the bitmap data including RGB color signals into the CMY colors or the CMYK colors that can be reproduced by a printer. C, M, Y and K represent the colors of cyan, magenta, yellow, and black, respectively.

The coding unit 24 compresses the bitmap data that has been converted into the CMY colors or the CMYK colors. The bitmap data compression system is not particularly limited, but a system that efficiently compresses multi-value bitmap data is desirable. As the compression system, either reversible compression or irreversible compression may be used. However, an irreversible compression system is usually employed.

As the bitmap data is compressed by the coding unit 24, the volume of data stored in the storage unit 25 can be reduced and the overall performance of the system can be enhanced.

The storage unit 25 includes a memory, HDD and so on, and temporarily stores the compressed bitmap data.

The decoding unit 26 reads out the bitmap data from the storage unit 25 and decodes this coded bitmap data.

The gamma correction unit 27 carries out gamma correction to realize calibration of image density corresponding to the properties of the engine 13 and preferred gradation characteristics.

Here, gamma correction is the correction of a gamma (γ) value, which is the ratio of change in voltage conversion value to change in brightness of an image. Specifically, it is a correcting operation to adjust the relation between the bitmap data and a signal at the time when the bitmap data is actually outputted, and thus provide a more natural display.

In the gamma correction unit 27, the type and setting of gamma correction processing can be switched by tag data in order to carry out optimum gamma conversion processing in consideration of the properties of each object (bitmap data).

When gamma data (gamma table value) stored in the gamma data storage unit 33 is convoluted, the gamma correction unit 27 can output an image with a good gamma property decided by a combination of the engine 13 and a designated halftone parameter.

The toner limiting unit 28 performs toner limiting processing to convert the setting of the quantity of CMYK of the bitmap data so that the total quantity of CMYK toners for the bitmap data falls within a printable range by the engine 13.

In the toner limiting unit 28, the type and setting of toner limiting processing can be switched by tag data in order to carry out optimum toner limiting processing in consideration of the properties of each object (bitmap data).

The halftone processing unit 29 carries out halftone processing for each color of CMYK and converts the bitmap data into bitmap data having a smaller number of gradation levels because of having a smaller number of bits of each color of CMYK in accordance with the printing capability of the printer.

As halftone processing, a dither method or a density pattern method is employed. In the case where the halftone processing is a dither method, an ordered dither method using a threshold matrix or a random dither method can be used as a dither method.

In the case where the halftone processing is a dither method, when this dither method includes multi-value dither processing with three or more multi-gradation levels in which plural planes are used, this method is preferable because the gradation of the bitmap data is expressed finely.

Halftone processing can be carried out in a dot-concentrated form or a dot-dispersed form.

Halftone processing is carried out in accordance with halftone processing conditions such as the number of lines, angle and shape set by the halftone setting unit 32.

In the halftone processing unit 29, the type and setting of halftone processing can be switched by tag data in order to carry out optimum halftone processing in consideration of the properties of each object (bitmap data).

The smoothing unit 30 carries out smoothing processing. Smoothing processing is the processing to perform pseudo high-resolution conversion of an image and thus make lines smoother than in the actual image or make lines thinner to reduce the quantity of toner consumption. An algorithm for smoothing processing is decided, for example, by the specifications of the number of PWM divisions of the engine 13.

In the smoothing unit 30, the type and setting of smoothing processing can be switched by tag data. The type and setting of smoothing processing is set in a way to carry out optimum smoothing processing in consideration of the properties of each object (bitmap data).

The halftone setting unit 32 is provided in the controller 12 of the image processing apparatus 10. The halftone setting unit 32 is to allow users to carry out setting of halftone processing at the halftone processing unit 29.

The halftone setting unit 32 may allow users to carry out setting of halftone processing for each object.

The halftone setting unit 32 is displayed, for example, as the setting screen 56 in the display section 15 of the operation panel 14 of the image processing apparatus 10, as shown in FIG. 3. By operating buttons or the like on the operation panel 14, the user can arbitrarily designate setting of a halftone parameter of halftone processing in the setting screen 56.

The setting of halftone processing by the halftone setting unit 32 is carried out, for example, by setting at least one of the halftone parameters including the number of lines, angle and dot shape.

The setting of halftone processing can also use a method of designating a mathematical formula like a vector, or a method of setting in the form of a natural language like newspaper or print, other than the method of setting at least one of the number of lines, angle and dot shape.

In the setting of halftone processing by the halftone setting unit 32, at least one of the number of lines, angle and dot shape is set for at least one color of CMYK.

Here, the number of lines is also referred to as the number of screen lines. When an array formed by the centroids of individual color material fixing areas is assumed to be a line, the number of such lines existing within a range of 25.4 mm (1 inch) is referred to as the number of lines (LPI).

The angle is also referred to as a screen angle. When an array formed by the centroids of individual color material fixing areas is assumed to be a line, the angle formed between this line and the print output direction is referred to as the angle.

The dot shape refers to the shape of each color material fixing area. As dot shapes, for example, halftone, line, chain type and so on are used.

Of the number of lines, angle and dot shape, particularly the value of the number of lines largely influences the gamma property of halftone processing. Therefore, it is preferable that the setting of halftone processing is carried out at least for the number of lines.

FIG. 3 is an example of setting the number of lines, angle and dot shape for each of the four colors of CMYK.

In FIG. 3, for example, the number of lines is “133” which is common to all of CMYK, and the dot shape is “Round” which is common to all of CMYK. The angle is “63” for C (cyan), “27” for M (magenta), “0” for Y (yellow) and “45” for K (black).

The setting of the number of lines, angle and dot shape is carried out by a method in which the user freely sets the number of lines and so on, or by a method in which the user selects predetermined setting.

The halftone setting unit 32 may set at least one of the number of lines, angle and dot shape for at least one color of CMYK, instead of setting for all of CMYK.

Also, the halftone setting unit 32 may be capable of selecting one of monochrome halftone processing and color halftone processing as halftone processing and capable of changing the setting range of a halftone parameter in accordance with the difference between color and monochrome modes and the difference between objects.

For example, when monochrome halftone processing is selected as halftone processing, at least one of the number of lines, angle and dot shape may be set for K, whereas when color halftone processing is selected, at least one of the number of lines, angle and dot shape may be set for at least one color of CMY.

As the setting range of a halftone parameter can be changed in accordance with the difference between color and monochrome modes for halftone processing, the troublesome to the user when selecting a halftone parameter is reduced, which is preferable.

When a gamma curve calculated on the basis of gamma data stored in the gamma data storage unit 33 is convoluted to the halftone parameter set by the halftone setting unit 32, an image with a good gamma property can be outputted. The gamma property is decided by the combination of the engine 13 and the designated halftone parameter.

In the gamma data storage unit 33, data to be used for gamma correction by the gamma correction unit 27 has been stored in advance. The data that has been stored in advance may be, for example, plural gamma data corresponding predetermined numbers of lines prepared for each number of lines.

As plural gamma data are provided, the user can interpolate plural gamma data into the value of the number of lines designated by the halftone setting unit 32, and thus can calculate a preferable gamma curve.

Also, the data stored in advance in the gamma data storage unit 33 may be, for example, a table having gamma data corresponding to each number of lines.

Moreover, the data stored in advance in the gamma data storage unit 33 may be gamma data corresponding to angles and dot shapes, instead of the numbers of lines. However, since the gamma property of halftone processing is strongly influenced by a change in the number of lines, it is preferable that the data is gamma data corresponding to the number of lines.

The data to be stored in advance in the gamma data storage unit 33 may be gamma data corresponding to at least one of angles and dot shapes in addition to the numbers of lines.

Halftone processing is processing that is substantially influence by the property of the engine 13. Therefore, generally, when the user arbitrarily designates a halftone parameter of halftone processing, the gamma property of an output image tends to change largely. For example, it often occurs that the image becomes denser as a whole and is crushed, or conversely, the image becomes thinner and a high-quality image cannot be provided.

However, when gamma correction is carried out by the gamma correction unit 27 using the data stored in advance in the gamma data storage unit 33, the gamma property of an output image can be made preferable even in the case the user has arbitrarily designated a halftone parameter of halftone processing.

The engine 13 converts bitmap data created by the controller 12 into a pulse wide modulation (PWM) signal for driving the laser, and thus accurately forms an image.

The operation panel 14 is provided on the face of a casing 17 of the image processing apparatus 10, and has buttons operable by the user such as ten keys 16 and the display section 15, as shown in FIG. 3. The display section 15 is capable of displaying at least one of the content of an operation and the result of an operation of the setting screen 56 and the like of the halftone processing unit 32.

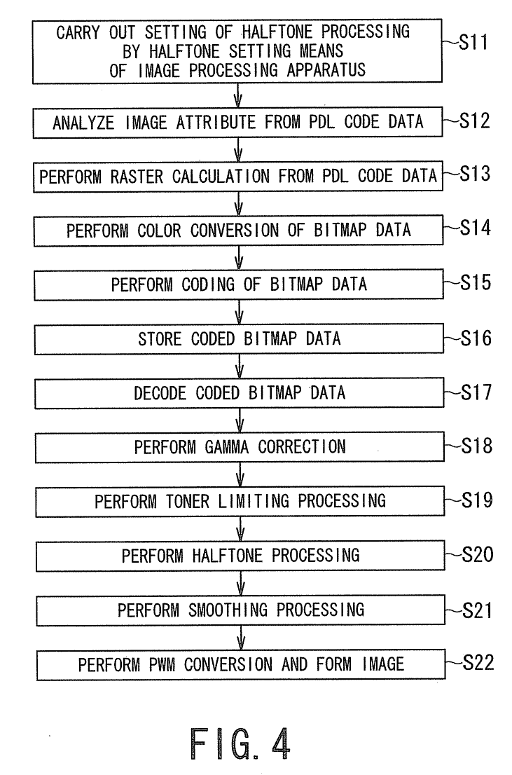

Next, the operation of the image processing system 1 according to the invention will be described. FIG. 4 is a flowchart showing the operation of the image processing system 1 according to the invention.

First, as a first halftone setting step, the halftone setting unit 32 of the image processing apparatus 10 carries out setting of halftone processing by the halftone processing unit 29 (step S11).

The setting of halftone processing is carried out on the setting screen 56 displayed in the display section 15 of the operation panel 14 of the image processing apparatus 10, for example, as shown in FIG. 3.

Next, as an image attribute analysis step, the image attribute analyzing unit 21 analyzes the attribute of image data of inputted code data in a page description language (step S12).

Moreover, as a raster calculation step, the raster calculating unit 22 converts the image data of the code data in the page description language into bitmap data (step S13).

Then, as a color conversion step, the color converting unit 23 performs color conversion of the bitmap data acquired as a result of the conversion by the raster calculating unit 22 (step S14).

Moreover, as a coding step, the coding unit 24 codes the bitmap data acquired as a result of the color conversion by the color converting unit 23 (step S15).

Also, as a storage step, the storage unit 25 stores the bitmap data acquired as a result of the coding by the coding unit 24 (step S16).

Furthermore, as a decoding step, the decoding unit 26 decodes the bitmap data stored in the storage unit 25 (step S17).

Also, as a gamma correction step, the gamma correction unit 27 performs gamma correction of the bitmap data acquired as a result of the decoding by the decoding unit 26 (step S18).

Moreover, as a toner limiting processing step, the toner limiting unit 28 performs toner limiting processing of the bitmap data acquired as a result of the gamma correction by the gamma correction unit 27 (step S19).

Also, as a first halftone processing step, the halftone processing unit 29 performs halftone processing of the bitmap data to which toner limiting processing has been performed, in accordance with the setting of halftone processing in the first halftone setting step (step S20).

Moreover, as a smoothing step, the smoothing unit 30 performs smoothing processing of the bitmap data to which halftone processing has been performed by the halftone processing unit 29 (step S21).

Also, as a PWM processing step, the engine 13 performs PWM processing of the smoothed bitmap data and outputs the image to a printer or the like (step S22).

With the image processing system 1 described in the first embodiment, the user can carry out setting of halftone processing with a high degree of freedom.

Although the image processing system 1 has a configuration including the printer driver-containing apparatus 40 and the display apparatus 50, the image processing system may have a configuration that does not include at least one of the printer driver-containing apparatus 40 and the display apparatus 50 when such is necessary.

With a configuration that does not include at least one of the printer driver-containing apparatus 40 and the display apparatus 50, simplification of the system and reduction in cost can be realized.

### Second Embodiment

Next, a second embodiment of an image processing system according to the invention will be described with reference to the drawings.

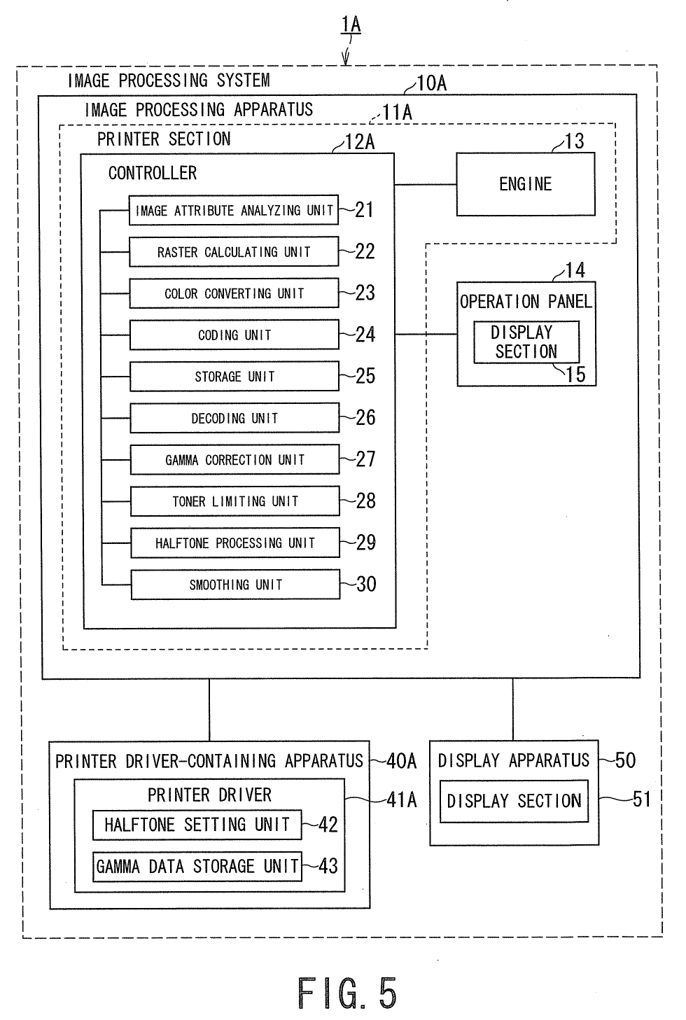

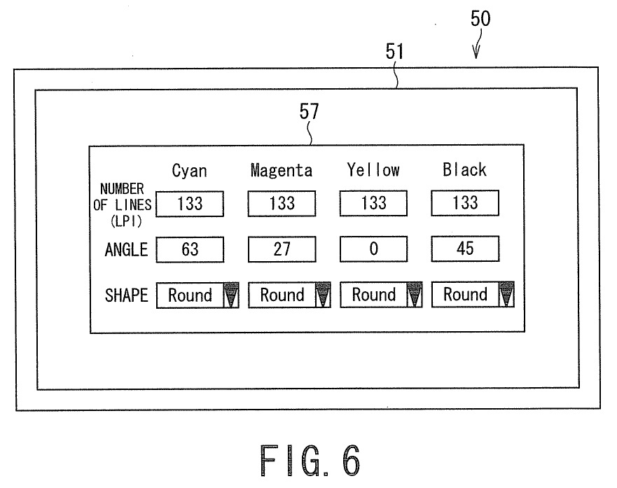

FIG. 5 is a detailed functional block diagram of an image processing system 1A. FIG. 6 is a view showing an exemplary setting screen 57 by a halftone setting unit 42, shown in the display section 51 of the display apparatus 50 of the image processing system 1A.

The image processing system 1A described in the second embodiment has the same configuration and operation as the image processing system 1 described in the first embodiment except that the image processing apparatus 10A is used instead of the image processing apparatus 10 and that the printer driver-containing apparatus 40A is used instead of the printer driver-containing apparatus 40. Therefore, the same configuration parts are denoted by the same reference numerals and the description of the configuration and operation will be simplified or omitted.

The image processing apparatus 10A has a configuration including a printer section 11A instead of the printer section 11, compared to the image processing apparatus 10 described in the first embodiment.

The printer section 11A has a configuration including a controller 12A instead of the controller 12, compared to the printer section 11 described in the first embodiment.

The controller 12A has a configuration that does not include the halftone setting unit 32 and the gamma data storage unit 33, compared to the controller 12 described in the first embodiment.

The printer driver-containing apparatus 40A has a configuration including a printer driver 41A instead of the printer driver 41, compared to the printer driver-containing apparatus 40 described in the first embodiment.

The printer driver 41A has a configuration including a halftone setting unit 42 and a gamma data storage unit 43, compared to the printer driver 41 described in the first embodiment.

The halftone setting unit 42 is provided in the printer driver 41A of the printer driver-containing apparatus 40A and enables the user to carry out setting of halftone processing at the halftone processing unit 29 of the image processing apparatus 10A, similarly to the halftone setting unit 32 described in the first embodiment.

The halftone setting unit 42 is displayed, for example, as the setting screen 57 in the display section 51 of the display apparatus 50, as shown in FIG. 6. The user can operate an input unit such as a mouse and keyboard, not shown, and can arbitrarily designate setting of a halftone parameter of halftone processing within the setting screen 57.

The setting of halftone processing by the halftone setting unit 42 is carried out similarly to the setting of halftone processing by the halftone setting unit 32 described in the first embodiment. Therefore, the description of the setting of halftone processing by the halftone setting unit 42 is omitted.

In the gamma data storage unit 43, data to be used for gamma correction by the gamma correction unit 27 of the image processing apparatus 10A has been stored in advance.

As the gamma data storage unit 43, means for performing the same operation as the gamma data storage unit 33 is provided in the printer driver 41A.

The data stored in advance in the gamma data storage unit 43 is the same as in the case of the gamma data storage unit 33. Therefore, the description of the data stored in advance is omitted.

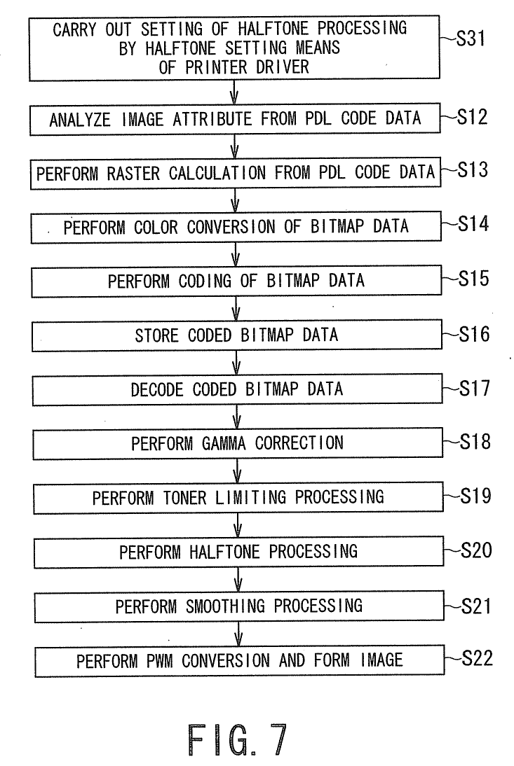

Next, the operation of the image processing system 1A according to the invention will be described. FIG. 7 is a flowchart showing the operation of the image processing system 1A according to the invention.

First, as a second halftone setting step, the halftone setting unit 42 provided in the printer driver 41A included in the printer driver-containing apparatus 40A carries out setting of halftone processing by the halftone processing unit 29 of the image processing apparatus 10A electrically connected to the printer driver-containing apparatus 40A (step S31).

The setting of halftone processing is carried out, for example, in the setting screen 57 displayed in the display section 51 of the display apparatus 50, as shown in FIG. 6.

After step S31, the same steps S12 to S22 as the operation of the image processing system 1 described in the first embodiment are carried out.

In a second halftone processing step as shown in step S20, halftone processing of bitmap data is carried out by the halftone processing unit 29 of the image processing apparatus 10A in accordance with the setting of halftone processing from the second halftone setting step.

The description of steps S12 to S19, step S21 and step S22 is omitted.

With the image processing apparatus 10A described in the second embodiment and the image processing system 1A including the image processing apparatus 10A, the user can carry out setting of halftone processing with a high degree of freedom.

Also, with the image processing apparatus 10A described in the second embodiment and the image processing system 1A including the image processing apparatus 10A, since the halftone setting unit 42 is provided in the printer driver 41A of the printer driver-containing apparatus 40A, the user can easily set halftone processing by using the printer driver-containing apparatus 40A such as a personal computer.

That is, the user does not have to go to the image processing apparatus 10 described in the first embodiment in order to set halftone processing and can easily set halftone processing at the user's desk and so on where the printer driver-containing apparatus 40A such as a personal computer is installed.

Moreover, with the image processing apparatus 10A described in the second embodiment and the image processing system 1A including the image processing apparatus 10A, since the gamma data storage unit 43 is provided in the printer driver 41A of the printer driver-containing apparatus 40A, simplification and reduction in cost of the image processing apparatus 10A can be realized.

As another embodiment of the image processing system 1 (1A), a configuration may be employed in which the halftone setting unit 32 (42) and the gamma data storage unit 33 (43) are included at least in one of the image processing apparatus 10 (10A) and the printer driver 41 (41A).

For example, the image processing system 1 described in the first embodiment can employ a configuration in which the halftone setting unit 42 is provided in the printer driver 41 of the printer driver-containing apparatus 40, instead of the halftone setting unit 32 in the image processing apparatus 10.

With this configuration, since the halftone setting unit 42 is provided in the printer driver 41 (41A) of the printer driver-containing apparatus 40 (40A), the user can easily set halftone processing by using the printer driver-containing apparatus 40 (40A) such as a personal computer.

Alternatively, the image processing system 1 described in the first embodiment can employ a configuration in which the halftone setting unit 42 is provided in the printer driver 41 of the printer driver-containing apparatus 40, in addition to the halftone setting unit 32 in the image processing apparatus 10.

With this configuration, the user can set halftone processing by the image processing apparatus 10. At the same time, since the halftone setting unit 42 is provided in the printer driver 41 (41A) of the printer driver-containing apparatus 40 (40A), the user can easily set halftone processing by using the printer driver-containing apparatus 40 (40A) such as a personal computer.

Moreover, the image processing system 1 described in the first embodiment can employ a configuration in which the gamma data storage unit 43 is provided in the printer driver 41 of the printer driver-containing apparatus 40, instead of the gamma data storage unit 33 in the image processing apparatus 10.

With this configuration, since the gamma data storage unit 43 is provided in the printer driver 41 of the printer driver-containing apparatus 40, simplification and reduction in cost of the image processing apparatus 10 can be realized.

Alternatively, the image processing system 1 described in the first embodiment can employ a configuration in which the gamma data storage unit 43 is provided in the printer driver 41 of the printer driver-containing apparatus 40, in addition to the gamma data storage unit 33 in the image processing apparatus 10.

With this configuration, since the gamma data storage unit 33 is provided in the image processing apparatus 10 and the gamma data storage unit 43 is provided in the printer driver 41 of the printer driver-containing apparatus 40, gamma correction can be securely carried out by the gamma correction unit 27 even when the condition of connection between the printer driver-containing apparatus 40 and the image processing apparatus 10 is poor.

Moreover, the image processing system 1 described in the first embodiment can employ a configuration in which the halftone setting unit 42 is provided in the printer driver 41 of the printer driver-containing apparatus 40, in addition to the halftone setting unit 32 in the image processing apparatus 10, and in which the gamma data storage unit 43 is provided in the printer driver 41 of the printer driver-containing apparatus 40, in addition to the gamma data storage unit 33 in the image processing apparatus 10.

With this configuration, the user can set halftone processing by the image processing apparatus 10 (10A). At the same time, since the halftone setting unit 42 is provided in the printer driver 41 (41A) of the printer driver-containing apparatus 40 (40A), the user can easily set halftone processing by using the printer driver-containing apparatus 40 (40A) such as a personal computer.

Also, since the gamma data storage unit 33 is provided in the image processing apparatus 10 (10A) and the gamma data storage unit 43 is provided in the printer driver 41 (41A) of the printer driver-containing apparatus 40 (40A), gamma correction can be securely carried out by the gamma correction unit 27 even when the condition of connection between the printer driver-containing apparatus 40 (40A) and the image processing apparatus 10 (10A) is poor.

What is claimed is:

1. An image processing system including a printer driver-containing apparatus in which a printer driver is included, an image processing apparatus connected to the printer driver-containing apparatus, and a display apparatus connected to the printer driver-containing apparatus and having a display section,
wherein the image processing apparatus comprises a halftone processing unit configured to perform halftone processing of bitmap data, and
a halftone setting unit configured to carry out setting of the halftone processing.

2. The image processing system according to claim 1, wherein the image processing apparatus further comprises an operation panel having a display section, and
the halftone setting unit provided in the image processing apparatus is displayed as a setting screen in the display section of the operation panel.

3. The image processing system according to claim 1, wherein the image processing apparatus further comprises
a gamma correction unit configured to perform, in advance, gamma correction of bitmap data used for the halftone processing by the halftone processing unit, and
a gamma data storage unit in which data used for the gamma correction by the gamma correction unit is stored in advance.

4. The image processing system according to claim 1, wherein the image processing apparatus further comprises a gamma correction unit configured to perform, in advance, gamma correction of bitmap data used for the halftone processing by the halftone processing unit, and
the printer driver-containing apparatus further comprises a gamma data storage unit in which data used for the gamma correction by the gamma correction unit provided in the image processing apparatus is stored in advance.

5. The image processing system according to claim 1, wherein the halftone processing by the halftone processing unit provided in the image processing apparatus is multi-value dither processing, and
the halftone setting unit provided in the image processing apparatus sets at least one of the number of lines, angle and dot shape.

6. The image processing system according to claim 1, wherein the halftone processing by the halftone processing unit provided in the image processing apparatus is multi-value dither processing, and
the halftone setting unit provided in the image processing apparatus sets at least one of the number of lines, angle and dot shape for at least one color of CMYK.

7. The image processing system according to claim 1, wherein the halftone processing by the halftone processing unit provided in the image processing apparatus is multi-value dither processing,
the halftone setting unit provided in the image processing apparatus is capable of selecting one of monochrome halftone processing and color halftone processing as the halftone processing, and
the halftone setting unit sets at least one of the number of lines, angle and dot shape for K when the monochrome halftone processing is selected, and sets at least one of the number of lines, angle and dot shape for at least one color of CMY when the color halftone processing is selected.

8. An image processing system including a printer driver-containing apparatus in which a printer driver is included, an image processing apparatus connected to the printer driver-containing apparatus, and a display apparatus connected to the printer driver-containing apparatus and having a display section,
wherein the printer driver included in the printer driver-containing apparatus has a halftone setting unit configured to carry out setting of halftone processing in the image processing apparatus, and
the image processing apparatus has a halftone processing unit configured to perform halftone processing of bitmap data.

9. The image processing system according to claim 8, wherein the halftone setting unit provided in the printer driver is displayed as a setting screen in the display section of the display apparatus.

10. The image processing system according to claim 8, wherein the image processing apparatus further comprises
a gamma correction unit configured to perform, in advance, gamma correction of bitmap data used for the halftone processing by the halftone processing unit, and
a gamma data storage unit in which data used for the gamma correction by this gamma correction unit is stored in advance.

11. The image processing system according to claim 8, wherein the image processing apparatus further comprises a gamma correction unit configured to perform, in advance, gamma correction of bitmap data used for the halftone processing by the halftone processing unit, and
the printer driver-containing apparatus further comprises a gamma data storage unit in which data used for the gamma correction by the gamma correction unit provided in the image processing apparatus is stored in advance.

12. The image processing system according to claim 8, wherein the halftone processing by the halftone processing unit provided in the image processing apparatus is multi-value dither processing, and
the halftone setting unit provided in the printer driver sets at least one of the number of lines, angle and dot shape.

13. The image processing system according to claim 8, wherein the halftone processing by the halftone processing unit provided in the image processing apparatus is multi-value dither processing, and
the halftone setting unit provided in the printer driver sets at least one of the number of lines, angle and dot shape for at least one color of CMYK.

14. The image processing system according to claim 8, wherein the halftone processing by the halftone processing unit provided in the image processing apparatus is multi-value dither processing,
the halftone setting unit provided in the printer driver is capable of selecting one of monochrome halftone processing and color halftone processing as the halftone processing, and
the halftone setting unit sets at least one of the number of lines, angle and dot shape for K when the monochrome halftone processing is selected, and sets at least one of the number of lines, angle and dot shape for at least one color of CMY when the color halftone processing is selected.

15. An image processing method comprising:
carrying out setting of halftone processing at a halftone processing unit, by a halftone setting unit provided in an image processing apparatus; and
performing halftone processing of bitmap data by the halftone processing unit in accordance with the setting of halftone processing.

16. The image processing method according to claim 15, wherein the setting of halftone processing is carried out in a setting screen displayed in a display section of an operation panel provided in the image processing apparatus.

17. The image processing method according to claim 15, further comprising gamma correcting performing, in advance, gamma correction of bitmap data used for the halftone processing at the halftone processing unit, by a gamma correction unit provided in the image processing apparatus.

18. The image processing method according to claim 15, wherein the halftone processing is multi-value dither processing, and
in the setting of halftone processing, at least one of the number of lines, angle and dot shape is set.

19. The image processing method according to claim 15, wherein the halftone processing is multi-value dither processing, and
in the setting of halftone processing, at least one of the number of lines, angle and dot shape is set for at least one color of CMYK.

20. The image processing method according to claim 15, wherein the halftone processing is multi-value dither processing, and
in the setting of halftone processing, after selection between monochrome halftone processing and color halftone processing as the halftone processing is made, at least one of the number of lines, angle and dot shape is set for K when the monochrome halftone processing is selected, and at least one of the number of lines, angle and dot shape is set for at least one color of CMY when the color halftone processing is selected.
